(19) United States
(12) Patent Application Publication
(10) Pub. No.: US 2015/0367785 A1
(43) Pub. Date: Dec. 24, 2015

(54) VEHICLE MOUNTED CARRIER DEVICE

(71) Applicant: Sarah Sanders, Marion, IL (US)

(72) Inventor: Sarah Sanders, Marion, IL (US)

(21) Appl. No.: 14/741,667

(22) Filed: Jun. 17, 2015

Related U.S. Application Data
(60) Provisional application No. 62/014,902, filed on Jun. 20, 2014.

(51) Int. Cl. B60R 9/06

(52) U.S. Cl. CPC B60R 9/06

(57) ABSTRACT

A carrier device for removably coupling to a vehicle hitch for supporting a carrier is provided. The carrier device includes a hitch connector and a riser support coupled to the hitch connector. A cross support is coupled to the riser support and configured to move between a first position and a second position. The cross support includes a pair of arms configured to couple to the carrier.

### CROSS REFERENCE TO RELATED APPLICATION

This non provisional application claims priority to U.S. Provisional Patent Application Serial No. 62/014,902 filed on Jun. 20, 2104, which is incorporated in its entirety by reference.

### BACKGROUND

The embodiments described herein relate generally to support racks, and more particularly, to methods and systems for stabilizing and mounting a carrier on a vehicle.

A number of stationary and collapsible bike carriers exist that can be removably connected to vehicle hitches. Conventional bike carriers include projecting arms or hangers that are spaced apart and structured so that the bike can be supported between front upper portions and middle upper portions. During use, the bike user may have to lift the bike off of the ground and place the bike on the arms. These conventional bike carriers may not be equipped or configured to accommodate carriers such as, but not limited to, wheelchairs, walkers, chairs, or similar articles of bulky and unusual shape. Moreover, individuals such as elderly, injured, and/or handicapped individuals using the bike support may need assistance for loading and unloading the carrier onto a conventional bike carrier.

In order to transport a carrier by way of a vehicle, for example an automobile, the carrier may typically be loaded into the back seat area of the vehicle which is tedious, awkward, time-consuming, and labor intensive. The wheelchair and/or walker can consume interior vehicle space that could otherwise be used by additional passengers and may necessitate using two vehicles to transport the carrier and the necessary passengers. Moreover, risk may exist that seat covers and upholstery will become ripped, gradually worn, smudged, etc. when the carrier is placed inside of the vehicle.

Existing wheelchair carriers may not be easily attachable to an automobile by persons lacking in mechanical skills Since a wheelchair user may be the individual desiring to carry the wheelchair utilizing the automobile, a necessity for a carrier that is easily attachable without assistance from others and which can be attached to the automobile in minimal time is readily apparent. Furthermore, the loading of the wheelchair to the carrier must be achievable by a person of minimal or limited strength which may present a problem because of the cumbersome structure and weight of wheelchairs.

A need has thus arisen for a carrier device and loading device which is easily attached to a vehicle by an elderly user or another individual without assistance from others and in a minimal amount of time. Furthermore, a need has arisen for a carrier device that will facilitate the connecting of the carrier with the device with minimal effort and which allows users to maintain independence and safety when a carrier is being supported by the carrier device.

### BRIEF DESCRIPTION OF THE INVENTION

In one aspect, a carrier device for removably coupling to a vehicle hitch for supporting a carrier is provided. The carrier device includes a hitch connector and a riser support coupled to the hitch connector. A cross support is coupled to the riser support and configured to move between a first position and a second position. The cross support includes a pair of arms configured to couple to the carrier.

In another aspect, a carrier system for removably coupling to a vehicle for supporting a carrier is provided. The carrier system includes a vehicle hitch and a hitch connector coupled to the vehicle hitch. The carrier system includes a riser support coupled to the hitch connector. A cross support is coupled to the riser support and configured to move between a first position and a second position with respect to the riser support. The cross support includes a pair of arms configured to couple to the carrier.

A method of assembling a carrier device is provided. The method includes coupling a riser support to a hitch connector. A cross support is coupled to the riser support, wherein the cross support is configured to move between a first position and a second position. The method includes coupling at least one fastener to the cross support. Moreover, the method includes coupling a pair of arms to the cross support.

### BRIEF DESCRIPTION OF THE DRAWINGS

These and other features, aspects, and advantages will become better understood when the following detailed description is read with reference to the accompanying drawings in which like characters represent like parts throughout the drawings, wherein:

FIG. 1 is a front view of an exemplary carrier device in a first position and a carrier such as a wheelchair;

FIG. 2 is a front view of the carrier device shown in FIG. 1 in a second position;

FIG. 3 is a side elevational view of another exemplary carrier device in a first position;

FIG. 4 is a side elevational view of the carrier device shown in FIG. 3 in a second position;

FIG. 5 is a front elevational view of another exemplary carrier device in a first position;

FIG. 6 is a front elevational view of the carrier device shown in FIG. 5 in a second position;

FIG. 7 is a front elevational view of the carrier device shown in FIG. 5 in a second position; and

FIG. 8 is a flowchart illustrating an exemplary method of assembling the tool stabilizer shown in FIG. 1.

Unless otherwise indicated, the drawings provided herein are meant to illustrate features of embodiments of the disclosure. These features are believed to be applicable in a wide variety of systems comprising one or more embodiments of the disclosure. As such, the drawings are not meant to include all conventional features known by those of ordinary skill in the art to be required for the practice of the embodiments disclosed herein.

### DETAILED DESCRIPTION

In the following specification and the claims, reference will be made to a number of terms, which shall be defined to have the following meanings. The singular forms “a”, “an”, and “the” include plural references unless the context clearly dictates otherwise. “Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about”, “approximately”, and “substantially”, are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

The embodiments described herein relate to stabilizing and mounting a carrier such as, but not limited to, a wheelchair and a walker on a vehicle. The embodiments also relate to methods, systems, and/or apparatus for suspending and selectively carriers for convenient and efficient loading and unloading of the carrier onto a vehicle. The embodiments also describe systems and methods to minimize stresses of the carrier weight being applied to the user. The embodiments described herein include a variety of types of carriers, and the descriptions and figures that utilize wheelchairs are examples only.

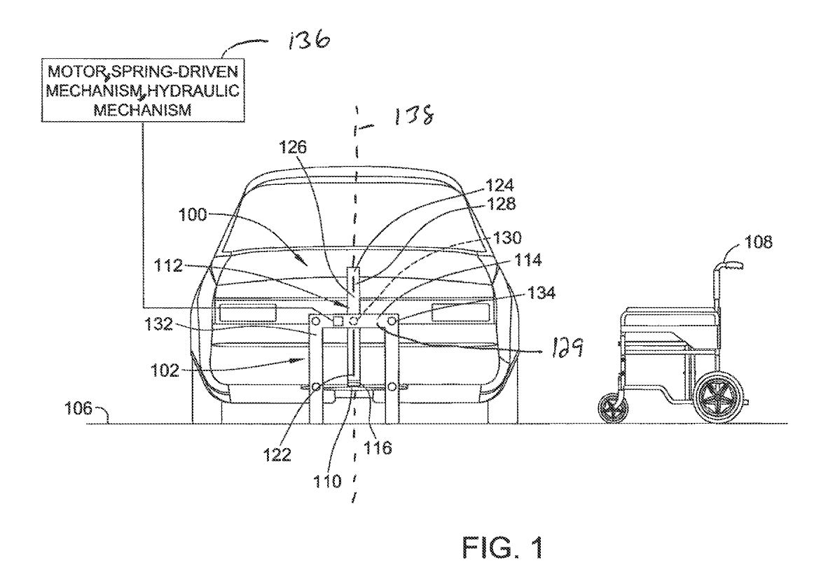

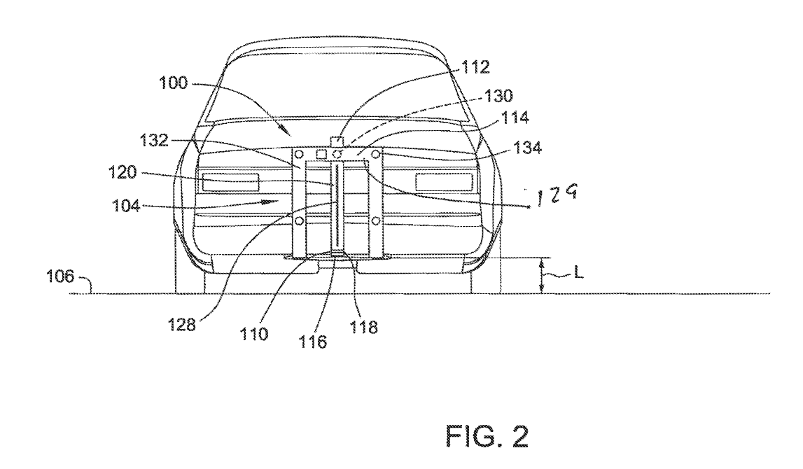

FIG. 1 is a front elevational view of a carrier device 100 in a first position 102. FIG. 2 is a front elevational view of carrier device 100 in a second position 104. In first position 102, such as a lowered or grounded position, carrier device 100 is in contact or substantially close to a surface 106 such as a ground surface or a pavement surface. In second position 104, carrier device 100 is positioned in an elevated position and positioned away from surface 106. More particularly, in second position 104, carrier device 100 is configured to move away from surface 106 and suspend above surface 106. Carrier device 100 is configured to removably couple to a carrier 108 such as, but not limited to, a wheelchair, a walker, and a chair. Carrier 108 can include any type of support apparatus to assist a person (not shown) such as, for example only, an elderly person, an injured person, and a handicapped person.

Carrier device 100 includes a hitch connector 110, a riser support 112, and a cross support 114. In the exemplary embodiment, hitch connector 110 is configured to removably couple to a vehicle hitch 116 such as, but not limited to, a receiver hitch, a ball mounted hitch, and a pin hitch. Hitch connector 110 may include, for example only, magnetic connectors, spring connectors, and peg connectors. Hitch connector 110 can include any configuration to facilitate removably coupling to any type of vehicle hitch 116. Moreover, the hitch connector 110 can also couple to the trunk and/or backside of the vehicle.

Riser support 112 is removably coupled to hitch connector 110. Riser support 112 includes a first leg 118 coupled to a second leg 120 at about a 90 degree angle. Alternatively, first leg 118 can couple to second leg 120 at any angle. In the exemplary embodiment, first leg 118 and second leg 120 can include channel members, bar members, and flat members and can include a plurality of material compositions such as, but not limited to, metals and plastics. Alternatively, first leg 118 and second leg 120 can include any configuration and material composition to enable carrier device 100 to function as described herein.

Second leg 120 includes a first end 122, a second end 124, and a body 126 extending between first end 122 and second end 124. Body 126 further includes an aperture 128 such as, for example only, at least one of a slot, a track and a groove. Body 126 has a length as measured between first end 122 and second end 124. In the exemplary embodiment, body 126 has a length from about 6 inches to about 5 feet. More particularly, body 126 has a length from about one foot to about 3 feet. Alternatively, body 126 can include any length to enable carrier device 100 to function as described herein.

Cross support 114 is coupled to riser support 112. More particularly, cross support 114 includes an extension 130 such as, for example, a tab or a gear that removably couples to body aperture 128. Cross support 114 is configured to move between first position 102 and second position 104 with respect to riser support 112. In the exemplary embodiment, cross support 114 includes a pair of arms 132 coupled to cross body 129. Arms 132 extend from cross body 129 and are substantially parallel to riser support 112. In the exemplary embodiment, cross body 129 and arms 132 can include channel members, bar members, and flat members and can comprise a plurality or material compositions such as, but not limited to, metals and plastics. Alternatively, cross support 114 can include any configuration and material composition to enable carrier device 100 to function as described herein.

In the exemplary embodiment, carrier device 100 includes at least one fastener 134 coupled to at least one arm 132 of the pair of arms 132. Fastener 134 is configured to removably couple carrier 108 to cross support 114. Fastener 134 includes connectors such as, for example only, a strap, a clip, a hook and loop fastener, a buckle, and a clamp. In an embodiment, fastener 134 can include a spring-loaded button. Alternatively, fastener 134 can include any configuration to enable connecting carrier 108 to cross support 114.

In the exemplary embodiment, a movement device 136 is coupled to riser support 112 and cross support 114. Movement device 136 is configured to reciprocally move cross support 114 relative to riser support 112. More particularly, cross support 114 is configured to move along an axis 138 of riser support 112 via movement device 136. Extension 130 is configured to move along and/or within aperture 128 between first position 102 and second position 104. Movement device 136 includes at least one of an electrical motor, a spring driven device, a hydraulically driven device, and a pneumatic driven device. Movement device 136 can include any configuration that facilitates moving cross support 114 relative to riser support 112. Riser support 112, cross supports, and/or arm 132 may include segmented lift/height positions such that movement device 136 is configured to selectively move cross support 114 to relative to riser support 112 to selective and different heights along riser support.

During an exemplary use, a user (not shown) moves carrier device 100 to first position 102. User can activate electrical motor to move cross support 114 along riser support 112 and to first position 102. Alternatively, users can efficiently, conveniently, and easily grasp cross support 114 and move cross support 114 manually to first position 102. Further, in another use, user can move spring-driven mechanism or and/or hydraulic mechanism to move cross support 114. At first position 102, arms 132 are in contact or are in near contact to surface 106. Moreover, in first position 102, arm is configured to position fastener 134 at a convenient height level to accept carrier 108.

User pushes and/or rolls carrier to couple carrier 108 to fastener 134. Since cross support 114 is lowered at first position 102, carrier 108 is presented at a convenient height level and user does not have to lift carrier 108 to couple carrier 108 to fastener 134. Instead, the user conveniently rolls or pushes carrier 108 along surface 106 and into contact with fastener 134. User than fastens carrier 108 to arm 132 via fastener 134.

User activates movement device 136 to move cross support 114 along riser support 112 from first position 102 to second position 104 and elevates carrier 108 from surface 106. Alternatively, spring driven mechanism and/or hydraulic mechanism facilitates moving cross support 114 from first position 102 to second position 104 relative to riser support 112. Moreover, user can also manually move cross support 114 from first position 102 to second position 104. In second position 104, carrier 108 is elevated or suspended from surface 106 by a length L having a range for about 6 inches to about 3 feet. Alternatively, length L can include and dimension to facilitate safely elevating carrier 108 from surface 108 while vehicle is parked and/or in motion.

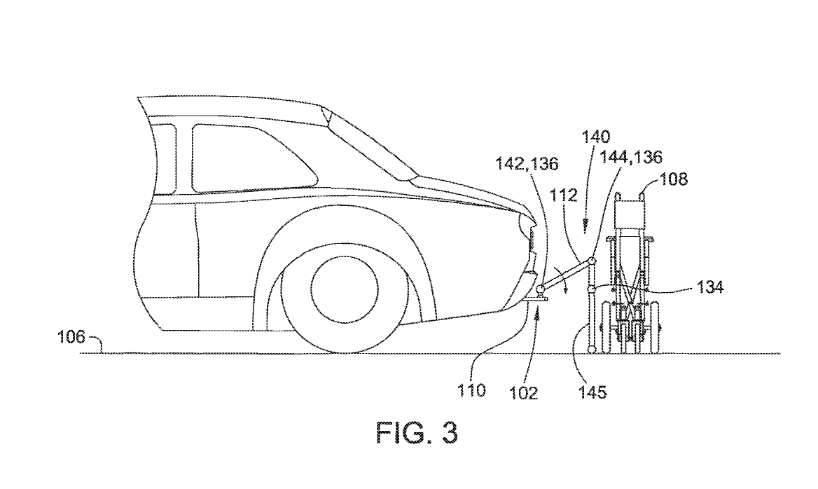

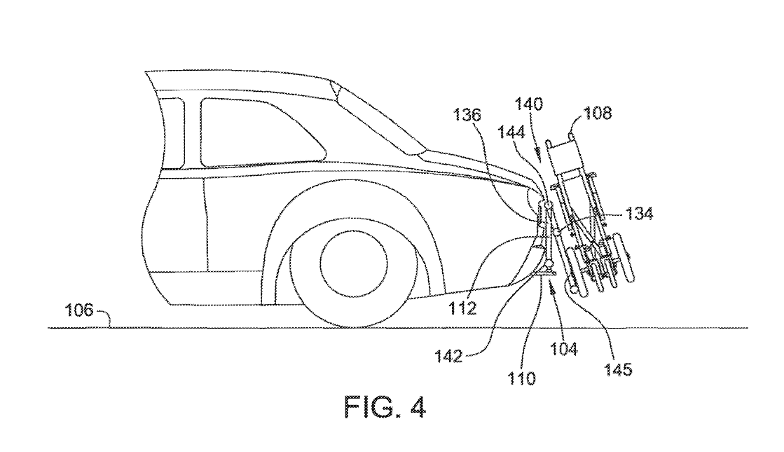

FIG. 3 is a side elevation view of another carrier device 140 shown in first position 102. FIG. 4 is a side elevational view of carrier device 140 shown in second position 104. In FIGS. 3 and 4, similar components include the same element numbers as components as shown in FIGS. 1 and 2. In the exemplary embodiment, carrier device 140 includes a first rotatable connector 142 coupled to hitch connector 110. The carrier device 140 further includes a second rotatable connector 144 coupled to riser support 112 and a support 145. Support 145 includes at least one fastener 134 that is configured to removable couple to carrier 108. First rotatable connector 142 and second rotatable connector 144 include configurations such as, but not limited to, hinges and ball connectors. First rotatable connector 142 and second rotatable connector 144 can include any configuration that enables rotational movement among riser support 112, hitch connector 110, and support 145.

In the exemplary embodiment, first rotatable connector 142 is configured to rotate riser support 112 with respect to hitch connector 110. More particularly, first rotatable connector 142 is configured to rotate riser support 112 relative to hitch connector 110 from about 5 degrees to about 180 degrees relative to hitch connector 110. Alternatively, first rotatable connector 142 can rotate rise support at any angle with respect to hitch connector 110. Second rotatable connector 144 is configured to rotate support 145 with respect to riser support 112. More particularly, second rotatable connector 144 is configured to rotate support 145 relative to riser support 112 from about 5 degrees to about 180 degrees. Alternatively, second rotatable connector 144 can rotate support 145 at any angle with respect to riser support 112.

In the exemplary embodiment, movement device 136 such as electrical motor is coupled to first rotatable connector 142. Movement device 136 is configured to move first rotatable connector 142 to facilitate rotating riser support 112 relative to hitch connector 110. Moreover, movement device 136 is coupled to second rotatable connector 144. Movement device 136 is configured to move second rotatable connector relative 144 to riser support 112 to facilitate rotating support 145 relative to riser support 112.

During an exemplary use, user (not shown) moves carrier device 140 to first position 102. User can activate movement device 136 such as, for example motor, to move first rotatable connector 142 to facilitate reciprocally rotating riser support 112 away from and toward surface 106. User can also activate motor to move second rotatable connector 142 to facilitate rotating support 145 away from riser support 112 and toward surface 106. User continues to move support 145 until support 145 contacts or nearly contact surface 106. Alternatively, to move first rotatable connector 142 and/or second rotatable connector 144, user can use spring driven mechanism and/or hydraulic mechanism. Moreover, user can also manually move first rotatable connector 142 and/or second rotatable connector 142 to facilitate rotating riser support 112 and support 145 respectively.

In first position 102, user pushes and/or rolls carrier 108 to fastener 134 and user couples carrier 108 to fastener 134. User activates movement device 136, such as motor, to move second rotatable connector 144 to facilitate rotating support 145 away from surface 106 and toward riser support 112. User activates motor to move first rotatable connector 142 to facilitate rotating riser support 112 toward hitch connector 110 and to elevate carrier 108 from surface 106. Alternatively, spring driven mechanism and/or hydraulic driven mechanism facilitate moving first rotatable connector 142 and/or second rotatable connector 144. Moreover, user can also manually move first rotatable connector 142 and/or second rotatable connector 144.

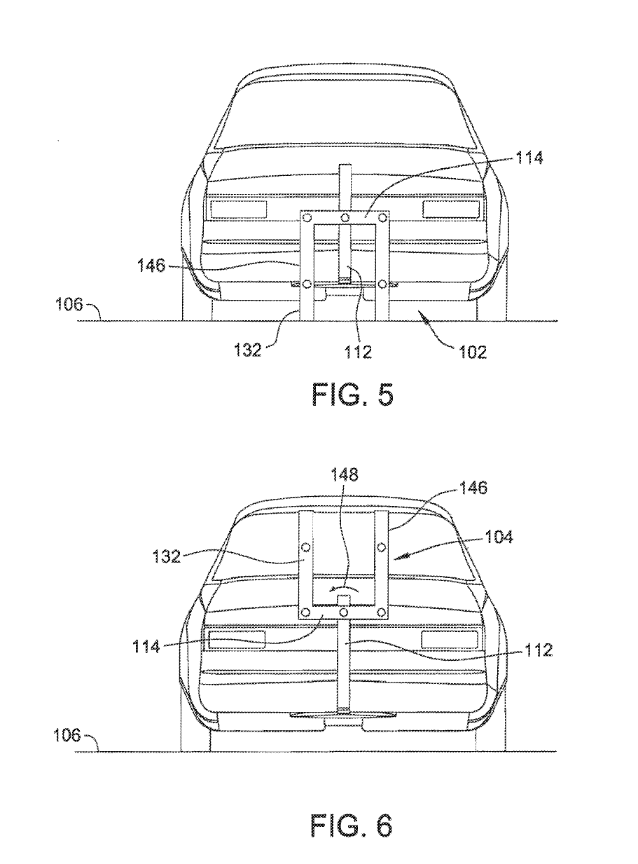

FIG. 5 is a front elevational view of another carrier device 146 in first position 102. FIG. 6 is a front elevation view of carrier device 146 in second position 104. In FIGS. 5 and 6, similar components include the same element numbers as component shown in FIGS. 1-4. In the exemplary embodiment, cross support 114 is rotatably connected to riser support 112 about axis of rotation 148. In first position 102, arm 132 is in contact or nearly in contact with surface 106. In second position 104, cross support 114 is configured to rotate about 180 degrees about axis of rotation 148 to position arm 132 elevated above surface 106. Alternatively, cross support 114 is configured to rotate about axis of rotation 148 at any angle to enable carrier device 146 to function as described herein. The cross support 114 can be configured to rotate either clockwise or counter-clockwise relative to the axis of rotation 148. In another embodiment, carrier device 146 may include a rotating cylinder (not shown) that is configured to couple to at least one of the riser support 112 and the cross support 114. In the embodiment, the rotating cylinder is configured to rotate the cross support 112 around the axis of rotation 148 such that the cross support 114 rotates the carrier 108 up from the ground surface 106 and toward the vehicle.

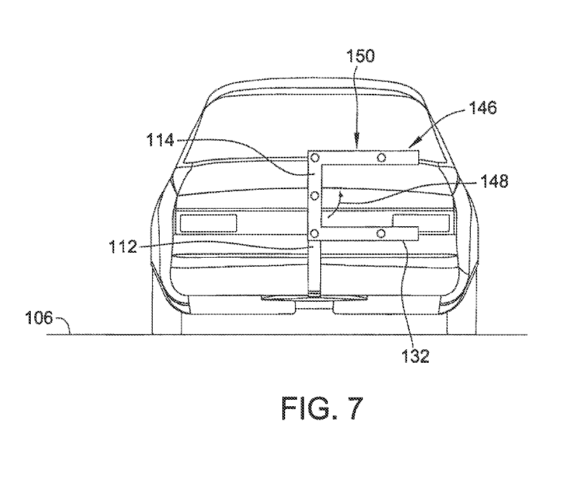

FIG. 7 is a front elevation view of carrier device 146 shown in another second position 150. In FIG. 7, similar components include the same element numbers as component shown in FIG. 1-6. In the exemplary embodiment, cross support 114 is rotatably connected to riser support 112 about axis of rotation 148. In first position 102 (shown in FIG. 5), arms 132 are in contact or immediately in contact with surface 106. In second position 104, cross support 114 is configured to rotate about 90 degrees about axis of rotation 148 to position arms 132 elevated above surface 106. Alternatively, cross support 114 is configured to rotate about axis of rotation 198 at any angle to enable carrier device 146 to function as described herein.

The carrier device, 100, carrier device 140, and the carrier device 146 may each include a single arm or multiple arms, single legs or multiple legs, single cross supports or multiple cross supports. Moreover, the carrier device, 100, carrier device 140, and the carrier device 146 may include U-shaped configurations or other non-U-shaped configurations. Still further, the carrier device, 100, carrier device 140, and the carrier device 146 may be rotatable around multiple axis of rotation relative to the vehicle.

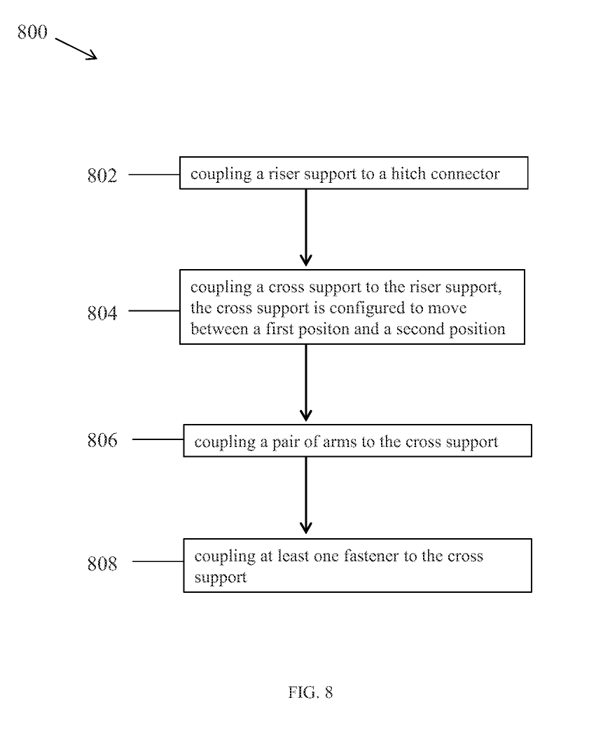

FIG. 8 is a flowchart illustrating an exemplary method 800 of assembling a carrier device, such as carrier device 100 (shown in FIG. 1). Method 800 includes coupling 802 riser support 112 to hitch connector 110 (both shown in FIG. 1). In the exemplary method 800, cross support 114 is coupled 804 to riser support 112, wherein cross support 114 is configured to move between first position 102 (shown in FIG. 1) and second position 104 (shown in FIG. 2). Method 800 includes coupling 806 the pair of arms 132 to cross support 114. Moreover, method 800 includes coupling 808 at least one fastener 134 to cross support 114.

The embodiments described herein provide cost-effective, safe, and efficient operation of mounting a carrier such as, for example a wheelchair, a walker, and a chair, to a vehicle. More particularly, the exemplary embodiments enable utilizing a carrier device that moves between a ground position and an elevated position. Moreover, the embodiments described herein provide for increased versatility of connecting the carrier to device. Still further, the embodiments described herein mitigate stresses applied by a carrier weight to the user.

The embodiments described herein provide a vehicle-mounted wheelchair support rack assembly with lifting capability so that the supported wheelchair can be lifted or raise above the ground a sufficient height to not interfere with the vehicle's operation. Another feature of the embodiments described herein is to provide a vehicle-mounted support rack assembly with lifting capability which is easy to install at the rear of the vehicle such as a hitch or the trunk. A further feature of the embodiments described herein is to provide a vehicle-mounted support rack assembly with lifting capability which is relatively structurally simple. Another feature of the embodiments described herein allows the user to maintain the user's independence with guarding the user's safety.

A further feature of the present invention is to provide a vehicle-mounted carrier assembly with lifting capability which is capable of elevating a wheelchair and/or walker above the ground at a variety of heights with little or no need for modifications to the rack assembly or vehicle. In other words, the vehicle-mounted wheelchair support rack assembly accommodates a variety of wheelchair heights (i.e., the distance from the bottom of the wheelchair's wheel to the horizontal bar of the wheelchairs arm) and a variety of vehicle elevations (i.e., the elevation of a vehicle's underside above the ground).

Another feature of the embodiments described herein is to provide a vehicle-mounted wheelchair support rack assembly with lifting capability having an assembly which provides a means for lifting the wheelchair essentially continuously within a defined range to a desired elevation to accommodate for the variety of wheelchair heights and the variety of vehicle elevations.

A technical effect of the systems and methods described herein includes at least one of: (a) utilizing a moveable cross support; (b) moving a carrier device between a ground position and an elevated position; (c) securing a carrier on a vehicle; and, (d) managing and/or mitigating stresses applied by the carrier's weight to a user.

Exemplary embodiments of a carrier device and methods for assembling a carrier device are described herein. The methods and systems are not limited to the specific embodiments described herein, but rather, components of systems and/or steps of the methods may be utilized independently and separately from other components and/or steps described herein. For example, the methods may also be used in combination with other manufacturing systems and methods, and are not limited to practice with only the systems and methods as described herein. Rather, the exemplary embodiment may be implemented and utilized in connection with many other tool applications.

Although specific features of various embodiments of the invention may be shown in some drawings and not in others, this is for convenience only. In accordance with the principles of the invention, any feature of a drawing may be referenced and/or claimed in combination with any feature of any other drawing.

This written description uses examples to disclose the embodiments, including the best mode, and also to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A carrier device for removably coupling to a vehicle hitch for supporting a carrier, said carrier device comprising:
a hitch connector;
a riser support coupled to said hitch connector; and
a cross support coupled to said riser support and configured to move between a first position and a second position, said cross support comprising a pair of arms configured to couple to the carrier.

2. The carrier device of claim 1 further comprising at least one fastener coupled to said cross support and configured to removably couple to the carrier.

3. The carrier device of claim 2 wherein said at least one fastener comprises at least one of a strap, a hook and loop fastener, and a clamp.

4. The carrier device of claim 1 further comprising a first rotatable connector coupled to said hitch connector and said riser support.

5. The carrier device of claim 4 further comprising a second rotatable connector coupled to said riser support and said cross support.

6. The carrier device of claim 1, wherein said cross support is configured to move along a lateral axis of said riser support and between the first position and the second position.

7. The carrier device of claim 1, wherein said cross support is configured to move about an axis of rotation of said riser support and between the first position and the second position.

8. The carrier device of claim 1 further comprising an electric motor coupled to said riser support and configured to move said cross support between the first position and the second position.

9. The carrier device of claim 1 further comprising a spring loaded device coupled to said riser support and configured to move said cross support between the first position and the second position.

10. The carrier device of claim 1 further comprising at least one of a spring-driven mechanism and a hydraulic driven mechanism coupled to said riser support and configured to move said cross support between the first position and the second position.

11. A carrier system for removably coupling to a vehicle for supporting a carrier, said carrier system comprising:
a vehicle hitch;
a hitch connector coupled to said vehicle hitch;
a riser support coupled to said hitch connector; and
a cross support coupled to said riser support and configured to move between a first position and a second position with respect to said riser support, said cross support comprising a pair of arms configured to couple to the carrier.

12. The carrier system of claim 11 wherein said riser support includes a slot.

13. The carrier system of claim 11 wherein said cross support includes a tab.

14. The carrier system of claim 11 wherein said riser support includes a slot and said cross support includes a tab coupled to said slot.

15. The carrier system of claim 11, wherein said pair of arms are coupled to said cross support and parallel to said riser support.

16. The carrier system of claim 11 further comprising a fastener coupled to at least one arm of said pair of arms.

17. The carrier system of claim 11 further comprising at least one fastener coupled to said cross support and configured to removably couple to the carrier.

18. A method of assembling a carrier device, said method comprising:
coupling a riser support to a hitch connector; and
coupling a cross support to the riser support, the cross support configured to move between a first position and a second position.

19. The method of claim 18 further comprising coupling at least one fastener to the cross support.

20. The method of claim 18 further comprising coupling a pair of arms to the cross support.
